(19) United States
(12) Patent Application Publication
(10) Pub. No.: US 2025/0349867 A1
(43) Pub. Date: Nov. 13, 2025

(54) FLOW BATTERY CELL AND METAL-AIR FLOW BATTERY CELL

(71) Applicant: Sharp Kabushiki Kaisha, Sakai City (JP)

(72) Inventors: TOMO KITAGAWA, Sakai City (JP); HIROTAKA MIZUHATA, Sakai City (JP); SHINOBU TAKENAKA, Sakai City (JP); AKIHITO YOSHIDA, Sakai City (JP)

(21) Appl. No.: 19/194,422

(22) Filed: Apr. 30, 2025

(30) Foreign Application Priority Data
May 9, 2024 (JP) 2024-076211

(51) Int. Cl. H01M 8/026; H01M 8/0263; H01M 8/0265

(52) U.S. Cl. CPC H01M 8/026; H01M 8/0263; H01M 8/0265

(57) ABSTRACT

A flow battery cell includes a separator, a negative electrode chamber, and a positive electrode chamber placed opposite the negative electrode chamber across the separator, wherein a flow path width of the positive electrode chamber is smaller than a flow path width of the negative electrode chamber.

### CROSS-REFERENCE TO RELATED APPLICATION

The present application claims priority from Japanese Application JP2024-076211, the content of which is hereby incorporated by reference into this application.

### BACKGROUND OF THE INVENTION

### 1. Field of the Invention

The present disclosure relates to a flow battery cell and a metal-air flow battery cell.

### 2. Description of the Related Art

Conventionally, there have been disclosed metal-air flow batteries.

For example, International Publication No. 2010/029758 discloses a polyelectrolyte fuel battery including a membrane electrode assembly (5) having a pair of electrodes (4a, 4b) between which a portion of a polyelectrolyte membrane (1) that is further inward than an outer edge of the polyelectrolyte membrane (1) is sandwiched, a first separator (6a), and a second separator (6b). Moreover, a first reactant gas flow path (8) is formed in one principal surface of the first separator (6a), and a second reactant gas flow path (9) is formed in one principal surface of the second separator (6b) so as to have second rib portions (12). The first reactant gas flow path (8) is formed such that the proportion of a first reactant gas flow path width to the second rib portions (12) in an upstream part (18b) of the first reactant gas flow path (8) is larger than the proportion of the first reactant gas flow path width to the second rib portions (12) in a downstream part (18c) of the first reactant gas flow path (8), and is formed such that the proportion of the first reactant gas flow path width to the second rib portions (12) in the upstream part (18b) of the first reactant gas flow path (8) is a predetermined proportion.

However, although the battery in International Publication No. 2010/029758 is characterized in that the ribs or the flow paths face each other across the membrane electrode assembly in the downstream part but, in the upstream part, a region in which the ribs face each other is smaller than a region in which the ribs and the flow paths face each other, International Publication No. 2010/029758 fails to describe a magnitude relationship between one electrode flow path width and another and shows weakness in deformation of a separator due to a pressure difference between a negative electrode chamber and a positive electrode chamber.

It is desirable to provide a flow battery that makes it possible to reduce a pressure difference between a negative electrode chamber and a positive electrode chamber by increasing pressure on the side of a positive electrode.

### SUMMARY OF THE INVENTION

According to an aspect of the disclosure, there is provided a flow battery cell including a separator, a negative electrode chamber, and a positive electrode chamber placed opposite the negative electrode chamber across the separator. A flow path width of the positive electrode chamber is smaller than a flow path width of the negative electrode chamber.

### BRIEF DESCRIPTION OF THE DRAWINGS

FIG. 1 is a schematic view of a metal-air flow battery according to the present disclosure;

FIG. 2 is a schematic exploded perspective view of a metal-air flow battery cell;

FIG. 3 is a schematic plan view of a negative-electrode energization plate;

FIG. 4 is a schematic plan view of a positive-electrode energization plate;

FIG. 5 is a schematic cross-sectional view of a metal-air flow battery cell according to the present disclosure;

FIG. 6 is an enlarged view of portion VI of FIG. 5;

FIG. 7 is a modification of FIG. 6;

FIG. 8 is a modification of FIG. 7;

FIG. 9 is a schematic cross-sectional view of a metal-air flow battery cell according to the present disclosure in which negative electrode chamber rib portions are disposed to overlap at least some positive electrode chamber rib portions;

FIG. 10 is a schematic cross-sectional view of a metal-air flow battery cell according to the present disclosure in which negative electrode chamber rib portions are disposed to overlap all positive electrode chamber rib portions;

FIG. 11 is an assembly diagram of the negative-electrode energization plate and the positive-electrode energization plate in which negative electrode chamber rib portions are placed orthogonal to positive electrode chamber rib portions; and

FIG. 12 is a diagram explaining that a back pressure valve or other devices are provided at an outlet and an inlet of a metal-air flow battery cell according to the present disclosure.

### DETAILED DESCRIPTION OF THE INVENTION

Preferable embodiments of the present disclosure are described in detail below with reference to the drawings. The present embodiments to be described below are not intended to unduly limit the contents of the present disclosure recited in the claims, and not all configurations described in the present embodiments are of necessity as solutions of the present disclosure.

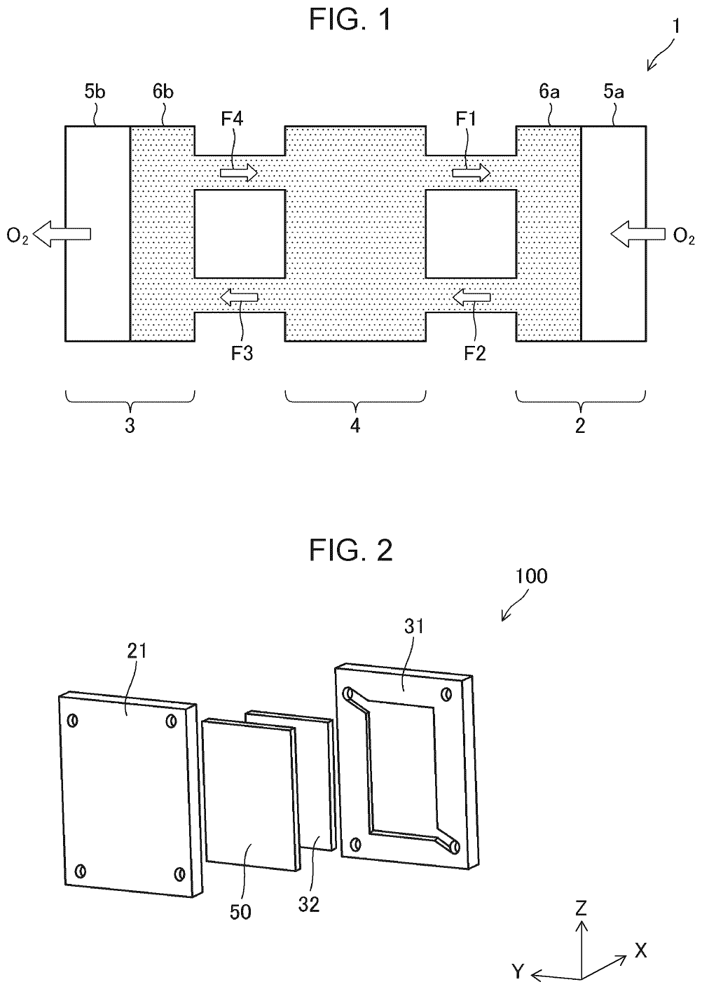

Although the preferable embodiments of the present disclosure and the drawings are described below by taking metal-air flow battery cells and metal-air flow batteries as examples, it is possible to apply any flow battery. For example, it is possible to apply a flow battery and a flow battery cell in which a liquid is used in the after-mentioned negative electrode portion and a gas is used in the after-mentioned positive electrode portion, a flow battery and a flow battery cell in which slurry is used in the negative electrode portion and a gas is used in the positive electrode portion, and a flow battery and a flow battery cell in which slurry is used in the negative electrode portion and a liquid is used in the positive electrode portion. For example, it is also possible to apply a fuel battery or other batteries. FIG. 1 is a schematic view of a metal-air flow battery 1 according to the present disclosure. The metal-air flow battery 1 includes a power-generating unit 2 that takes in air and generates electricity, a charging unit 3 that carries out charging and emits air, and a storage unit 4 in which slurry is stored. The power-generating unit 2 includes a positive electrode portion 5a having a positive electrode and a negative electrode portion 6a having a negative electrode. The charging unit 3 includes a positive electrode portion 5b having a positive electrode and a negative electrode portion 6b having a negative electrode. The power-generating unit 2 is constituted, for example, by a cell including the positive electrode portion 5a and the negative electrode portion 6a, and the charging unit 3 is constituted, for example, by a cell including the positive electrode portion 5b and the negative electrode portion 6b. The storage unit 4 may include a stirring machine that stirs the slurry.

The metal-air flow battery 1 is a battery that carries out power generation and charging by letting the slurry circulate (flow) among the power-generating unit 2, the charging unit 3, and the storage unit 4. For example, the metal-air flow battery 1 sends slurry containing a metal (e.g. zinc) and an electrolytic solution to the negative electrode portion 6a of the power-generating unit 2 (F1). The power-generating unit 2 generates electricity by oxidizing the metal with oxygen (O₂) taken in through the positive electrode portion 5a and taking out electrons from the metal. The slurry containing the metal thus oxidized is sent to the storage unit 4 (F2). Further, for example, the metal-air flow battery 1 sends the slurry containing the metal (e.g. zinc oxide) thus oxidized and the electrolytic solution to the negative electrode portion 6b of the charging unit 3 (F3). The charging unit 3 reduces the metal thus oxidized and separates the oxygen from the metal. The oxygen thus separated is released from the positive electrode portion 5b, and the slurry containing the metal from which the oxygen has been separated is sent to the storage unit 4 (F4). In the case of use in a flow battery other than a metal-air flow battery, some types of battery may be configured using a gas other than oxygen, slurry, or an electrolytic solution at the positive electrode portions 5a and 5b, and some types of battery may use appropriately varied metallic species of slurry at the negative electrode portions 6a and 6b. The following describes a configuration of a metal-air flow battery cell 100.

FIG. 2 is a schematic exploded perspective view of a metal-air flow battery cell 100. The metal-air flow battery cell 100 includes a positive-electrode energization plate 31 forming the positive electrode portion 5a, a negative-electrode energization plate 21 forming the negative electrode portion 6a, and a separator 50 placed between the positive electrode portion 5a and the negative electrode portion 6a. The positive electrode portion 5a includes a positive electrode 32. The positive-electrode energization plate 31 and the negative-electrode energization plate 21 are formed, for example, in the shape of a plate and joined on top of each other via the separator 50 or other components. The following description assumes that a direction in which the positive-electrode energization plate 31 and the negative-electrode energization plate 21 are joined on top of each other is an X-axis direction, that one direction in a plane perpendicular to the X axis is a Y-axis direction, and that a direction perpendicular to the X-axis direction and the Y-axis direction is a Z-axis direction. The power-generating unit 2 may be formed, for example, by joining a plurality of the metal-air flow battery cells 100 on top of each other in the X-axis direction.

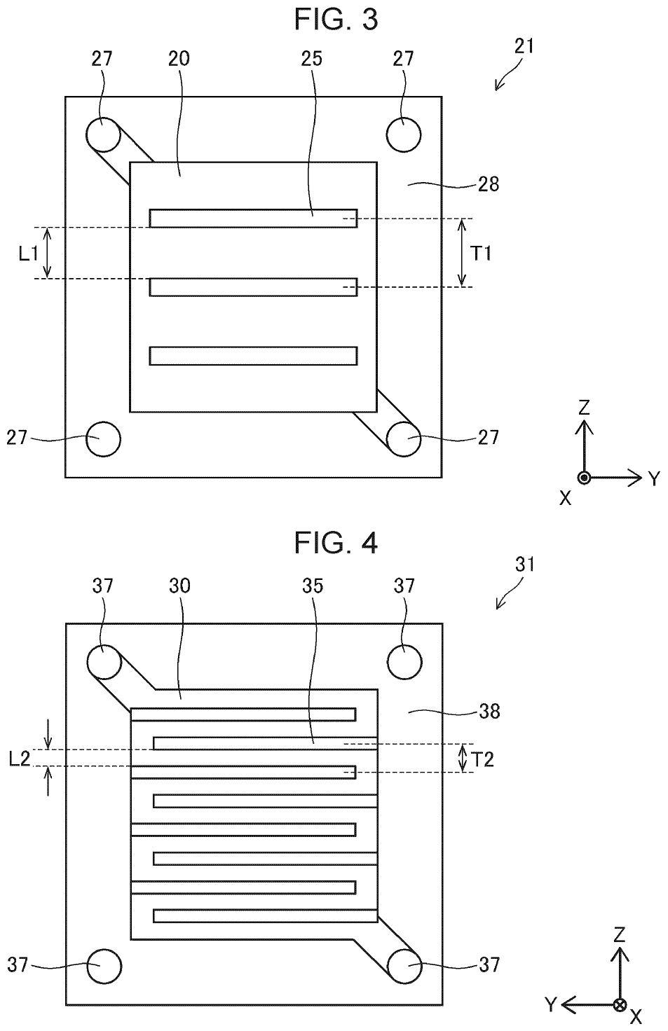

FIG. 3 is a schematic plan view of the negative-electrode energization plate 21. The negative-electrode energization plate 21 has a negative-electrode energization plate end portion 28 directly or indirectly covering at least part of a negative electrode chamber 20 through which the slurry flows and surrounding the negative electrode chamber 20. In the negative-electrode energization plate end portion 28, negative-electrode energization plate manifolds 27 bored through the negative-electrode energization plate 21 in the X-axis direction are formed.

In the negative electrode chamber 20, there may be one or more negative electrode chamber rib portions 25 formed in the shape of a wall. The negative electrode chamber rib portions 25 control the flow of the slurry flowing through the negative electrode chamber 20. The negative electrode chamber rib portions 25 may be integrally provided in the negative electrode chamber 20, or as shown in FIG. 3, each negative electrode chamber rib portion 25 in the negative electrode chamber 20 may be provided opposite the other. The negative-electrode energization plate 21 may be provided integrally with the negative electrode chamber rib portions 25 or may be provided as a separate component. Let it be assumed that a width parallel with a direction perpendicular to a direction in which a rib extends is a “rib width”. For example, in a case where a rib extends in the Y-axis direction as shown in FIG. 3, let it be assumed that a width parallel with the X-axis direction is a “rib width”. A space between one surface of a side wall of a rib and a surface of a rib adjacent to the surface that faces the surface is called “flow path”, and a distance between side surfaces of ribs facing each other is a flow path width L1. The term “flow path” may refer to a space between a surface of a side wall of the after-mentioned negative electrode flow path layer 23 or the negative-electrode energization plate end portion 28 that faces the negative electrode chamber 20 and a surface of a rib adjacent to the surface that faces the surface or a space between a surface of a side wall of the negative electrode flow path layer 23 that faces the negative electrode chamber 20 and a surface of the negative electrode flow path layer 23 or the negative-electrode energization plate end portion 28 that faces the surface, and a distance between side surfaces facing each other in that case may be a flow path width L1. Further, the negative electrode chamber rib portions 25 may be placed at pitches T1 each of which is a distance between straight lines passing through the midpoints of the “rib widths” of two ribs in parallel with a direction in which the ribs extend.

FIG. 4 is a schematic plan view of the positive-electrode energization plate 31. The positive-electrode energization plate 31 has a positive electrode chamber 30 through which air flows and a positive-electrode energization plate end portion 38 surrounding the positive electrode chamber 30, and in the positive-electrode energization plate end portion 38, positive-electrode energization plate manifolds 37 bored through positive-electrode energization plate 31 are formed.

In the positive electrode chamber 30, there are provided one or more positive electrode chamber rib portions 35 formed in the shape of a wall. The positive electrode chamber rib portions 35 control the flow of the air flowing through the positive electrode chamber 30. The positive electrode chamber rib portions 35 may be integrally provided in the positive electrode chamber 30, or as shown in FIG. 4, each positive electrode chamber rib portion 35 in the positive electrode chamber 30 may be provided opposite the other. The positive-electrode energization plate 31 may be provided integrally with the positive electrode chamber rib portions 35 or, if the positive electrode chamber rib portions have electrical conductivity and the positive-electrode energization plate and the positive electrode are electrically connected, may be provided as a separate component. Let it be assumed that a width parallel with a direction perpendicular to a direction in which a rib extends is a “rib width”. For example, in a case where a rib extends in the Y-axis direction as shown in FIG. 4, let it be assumed that a width parallel with the X-axis direction is a “rib width”. A space between one surface of a side wall of a rib and a surface of a rib adjacent to the surface that faces the surface is called “flow path”, and a distance between side surfaces of positive electrode chamber rib portions 35 facing each other is a flow path width L2. The term “flow path” may refer to a space between a surface of a side wall of the after-mentioned positive-electrode energization plate end portion 38 that faces the positive electrode chamber 30 and a surface of a rib adjacent to the surface that faces the surface or a space between a surface of a side wall of the positive-electrode energization plate end portion 38 that faces the positive electrode chamber 30 and a surface of the positive-electrode energization plate end portion 38 that faces the surface, and a distance between side surfaces facing each other in that case may be a flow path width L2. Further, the positive electrode chamber rib portions 35 may be placed at pitches T2 each of which is a distance between straight lines passing through the midpoints of the “rib widths” of two ribs in parallel with a direction in which the ribs extend.

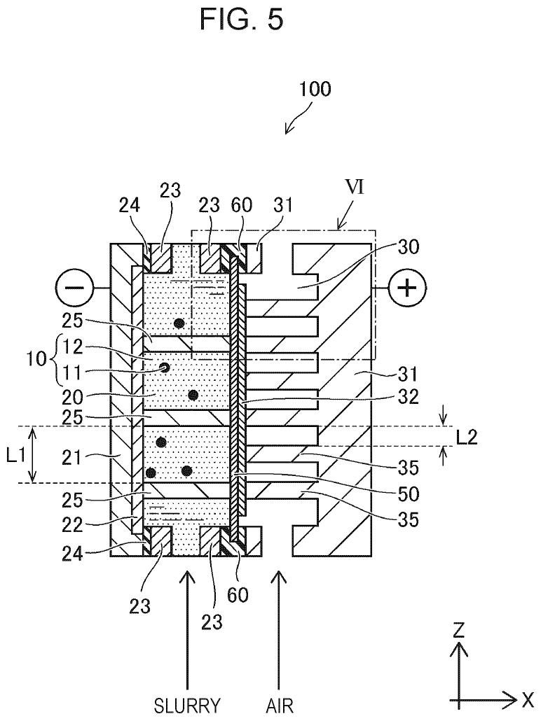

FIG. 5 is a schematic cross-sectional view of a metal-air flow battery cell 100 according to the present disclosure. As shown in FIG. 5, the metal-air flow battery cell 100 according to the present disclosure includes a negative electrode 22, a negative electrode flow path layer 23, a gasket 24, and a sealing portion 60 in addition to the negative-electrode energization plate 21, the positive electrode 32, the positive-electrode energization plate 31, and the separator 50. The metal-air flow battery cell 100 according to the present disclosure is fabricated by joining these components on top of each other. Further, the metal-air flow battery cell 100 according to the present disclosure includes negative electrode chamber rib portions 25 formed in the negative electrode chamber 20 and positive electrode chamber rib portions 35 formed in the positive electrode chamber 30. The negative electrode chamber rib portions 25 may be part of the negative electrode 22 or may be part of the negative electrode flow path layer 23. The negative electrode 22 may serve also as the negative-electrode energization plate 21 and, in that case, the negative electrode chamber rib portions 25 may be part of the negative-electrode energization plate 21. The positive electrode chamber rib portions 35 may be part of the positive-electrode energization plate 31 or may be made of an electrically conducting material.

The negative electrode chamber 20 is supplied with the after-mentioned slurry 10. The slurry 10 flowing through the negative electrode chamber 20 flows into the negative electrode chamber 20 through a negative-electrode energization plate manifold 27 (see FIG. 3) situated on a +Y-axis side and a −Z-axis side. The flow of the slurry 10 having entered the negative electrode chamber 20 is controlled by the negative electrode chamber rib portions 25 in a case where the negative electrode chamber rib portions 25 are provided, and the slurry 10 flows out of the negative electrode chamber 20 through a negative-electrode energization plate manifold 27 (see FIG. 3) situated on a −Y-axis side and a +Z-axis side. FIG. 5 shows a state in which the slurry 10 flows into the negative electrode chamber 20 from the −Z-axis side and flows out of the negative electrode chamber 20 from the +Z-axis side. The slurry 10 may flow through the positive electrode chamber 30 in a similar manner.

The negative electrode chamber 20 is a space defined by the separator 50, the negative electrode flow path layer 23, and the negative electrode 22. Further, the negative electrode chamber 20 can assume various shapes depending on the negative electrode 22 and the negative electrode flow path layer 23.

The negative-electrode energization plate 21 includes the negative electrode chamber 20 through which the slurry 10 flows. Further, the negative-electrode energization plate 21 is made of an electrically conducting material that passes an electric current to the negative electrode 22. The negative-electrode energization plate 21 may assume any shape.

The negative electrode 22 is made of an electrically conducting material that is corrosive-resistant against the slurry 10. The negative electrode 22 and the negative-electrode energization plate 21 may be constituted by separate members as shown in FIG. 5, or the negative electrode 22 may serve also as the negative-electrode energization plate 21. Furthermore, the negative electrode 22 or the negative-electrode energization plate 21 may serve also as the negative electrode chamber rib portions 25.

The gasket 24 is sandwiched between the negative electrode flow path layer 23 and the negative electrode 22 and/or the negative-electrode energization plate 21 to avoid leakage of the slurry 10.

The negative electrode flow path layer 23 may be formed in the shape of a frame so as to overlap the negative-electrode energization end portion 28 of the negative-electrode energization plate 21. The term “end portion” herein refers to a region of the member including the outermost periphery. Further, the negative electrode flow path layer 23 may be sandwiched between the separator 50 and the negative electrode 22 and/or the negative-electrode energization plate 21. Further, the negative electrode 22 may serve also as the negative electrode flow path layer 23, and in the case, the gasket 24 is not provided.

For example, a substance that flows through the positive electrode chamber 30 is lower in viscosity than a substance that flows through the negative electrode chamber 20. That is, for example, in a case where the slurry 10 flows through the negative electrode chamber 20, a substance that is lower in viscosity than the slurry 10 flows through the positive electrode chamber 30. Examples of the substance include a gas. The gas may be, for example, air or oxygen that is taken in or flows in from outside the positive electrode chamber 30. The positive electrode chamber 30 is a space defined by the positive electrode 32 and the positive-electrode energization plate 31. The positive electrode chamber 30 can assume various shapes depending on the positive-electrode energization plate 31.

The positive electrode 32 is made of an electrically conducting material and is not limited in shape. Further, the positive electrode 32 may be provided with a flow path. Further, the positive electrode 32 may contain water-repellent resin, a conductive auxiliary agent, and/or a catalyst or other substance and may include fine pores and have porosity.

Further, the positive-electrode energization plate 31 is made of an electrically conducting material that passes an electric current to the positive electrode 32.

Moreover, the flow path width L2 of the positive electrode chamber 30 is characterized by being smaller than the flow path width L1 of the negative electrode chamber 20. Since a substance that flows through the negative electrode chamber 20 is higher in viscosity than a substance that flows through the positive electrode chamber 30, pressure in the negative electrode chamber 20 tends to be higher than pressure in the positive electrode chamber 30. Meanwhile, making the flow path width L2 smaller than the flow path width L1 makes it possible to reduce a pressure difference between the negative electrode chamber 20 and the positive electrode chamber 30 by increasing pressure on the side of the positive electrode 32, for example, because in a case where a fluid flows through a flow path at a certain flow rate, the velocity of flow becomes higher as the flow path width (cross-sectional area of the flow path) becomes smaller, with the result that pressure on a flow path wall surface becomes higher. This makes it possible to inhibit battery performance from being diminished by the pressure difference between the negative electrode chamber 20 and the positive electrode chamber 30 causing an electrolytic solution 12 contained in the slurry 10 to exude to the positive electrode chamber 30 beyond the separator 50 to undesirably cover the positive electrode 32 exposed to the positive electrode chamber 30 so that the oxygen or other gases become unable to reach inside the positive electrode 32 and to go beyond the separator 50 and excessively penetrate into the fine pores of the positive electrode 32 so that the positive electrode 32 becomes unable to react with oxygen or other gases. Furthermore, this makes it possible to reduce leakage of the electrolytic solution 12 contained in the slurry 10 due to perforation and breakage due to deformation of the separator 50 and the positive electrode 32 by the pressure difference between the negative electrode chamber 20 and the positive electrode chamber 30. Further, this makes it possible to inhibit a change in composition of the slurry 10 and inhibit closure by the electrolytic solution 12 of the fine pores of the positive electrode 32 placed in the positive electrode chamber 30. Accordingly, the metal-air flow battery cell 100 makes a stable battery reaction possible.

In the case of a stack structure in which a plurality of the metal-air flow battery cells 100 are joined on top of each other, the negative-electrode energization plate 21 and the positive-electrode energization plate 31 of adjacent cells may be formed by a single member called “bipolar plate”.

The separator 50 is provided between the negative electrode flow path layer 23 and the positive electrode 32 and inhibits the electrolytic solution 12 contained in the slurry 10 from excessively penetrating from the negative electrode chamber 20 into the positive electrode chamber 30. In a case where a solid active material 11 is contained in the slurry 10, the separator 50 inhibits contact between the solid active material 11 contained in the slurry 10 and the positive electrode 32. Further, in a case where the negative electrode chamber rib portions 25 are part of the negative electrode flow path layer 23, the separator 50 also inhibits electrical contact between the negative electrode 22 and the positive electrode 32, if the negative electrode flow path layer 23 is made of an electrically conducting material.

Further, the separator 50 may be a hydrogel membrane. The hydrogel membrane may be a polymer having a crosslinking point and having a cation exchange group or an anion exchange group and be a substance having the property to swell due to moisture in the electrolytic solution 12. Utilizing such a material as the separator 50 makes it possible to, even in a case where there is a pressure difference between the negative electrode chamber 20 and the positive electrode chamber 30, inhibit the electrolytic solution 12 from excessively penetrating from the negative electrode chamber 20 into the positive electrode chamber 30.

The sealing portion 60 is provided between the negative electrode flow path layer 23 and the positive-electrode energization plate 31. The sealing portion 60 may be formed in the shape of a frame in end portions of the separator 50 and the positive electrode 32. Thus, the sealing portion 60 inhibits the slurry 10 from flowing into the positive electrode chamber 30 due to a force with which the negative electrode flow path layer 23 and the positive-electrode energization plate 31 press each other.

The slurry 10 contains the electrolytic solution 12 and an active material. The active material may be either one dissolved in the electrolytic solution 12 or the solid active material 11, which is undissolved in the electrolytic solution 12 beyond saturation solubility and has electron conductivity, or both of them. In a case where the slurry 10 contains the solid active material 11, the object of the present application becomes prominent to have a beneficial effect.

The active material is a negative-electrode active material. The negative-electrode active material is a metallic species. The metallic species is, for example, a zinc species, a cadmium species, a lithium species, a sodium species, a magnesium species, a lead species, a tin species, an aluminum species, or an iron species. The metallic species may be constituted by a metal composed only of a metal serving as a prime constituent or may be constituted by an alloy of a metal serving as a prime constituent and an accessory constituent. The metallic species can become either a metal or an oxide. Whether the metallic species becomes a metal or an oxide is determined according to the extent of progress of a discharging reaction or a charging reaction.

In shipping of the metal-air flow battery cell 100, the metallic species can become either a metal or an oxide. The state of oxidation of the metallic species may be homogenous within the negative-electrode active material or may be heterogeneous within the negative-electrode active material. For example, in the case of progress of a discharging reaction or a charging reaction from a surface of the negative-electrode active material toward the center of the negative-electrode active material, the state of oxidation of the metallic species on the surface of the negative-electrode active material may be different from the state of oxidation of the metallic species at the center of the negative-electrode active material.

In the metal-air flow battery cell 100 according to the present disclosure, a zinc species is taken as an example of the metallic species, and a zinc air battery is taken as an example of the metal-air flow battery cell 100. The zinc species may be constituted by a metal composed only of zinc serving as a prime constituent or may be constituted by an alloy of zinc serving as a prime constituent and an accessory constituent.

The metallic species has an average particle diameter of several micrometers when it is an oxide (e.g. ZnO) in a state of oxidation and has an average particle diameter of approximately several tens of micrometers to 300 μm when it is in a state of reduction (e.g. Zn) in which it is not an oxide. The average particle diameter can be measured by a particle size distribution measuring apparatus. The particle size distribution measuring apparatus, for example, measures a particle size distribution by laser diffractometry/scattering and calculates a median diameter as the average particle diameter from the particle size distribution thus measured.

The electrolytic solution 12 is selected according to the metallic species. In a case where the metallic species is a zinc species, the electrolytic solution 12 is an alkaline aqueous solution such as an aqueous solution of potassium hydroxide or an aqueous solution of sodium hydroxide. In a case where the metallic species is a lithium species, the electrolytic solution 12 is an non-aqueous electrolytic solution. In a case where the metallic species is a magnesium species, the electrolytic solution 12 is a neutral aqueous solution such as an aqueous solution of sodium chloride.

As mentioned above, the slurry 10 may contain the solid active material 11. In a case where the electrolytic solution 12 contains a metallic species such as a zinc species and a strong alkaline aqueous solution such as an aqueous solution of potassium hydroxide as a solvent, the metallic species, such as zinc oxide or zinc, dissolves when the concentration of the metallic species is lower than or equal to the saturation solubility, and the metallic species, such as zinc oxide or zinc, does not dissolve but comes to exist as the solid active material 11 when the concentration of the metallic species, such as zinc oxide or zinc, becomes higher than the saturation solubility. Further, solid active material particles can be judged by the way they look. In a case where the electrolytic solution 12 contains solid active material particles (particles oversaturated and undissolved) are contained, the electrolytic solution 12 is a suspension that is white in a case where the active material is zinc oxide. Meanwhile, in a case where the electrolytic solution 12 is a saturated solution, the electrolytic solution 12 is transparent, as the metallic species is dissolved. Whether the solid active material 11 is contained in the slurry 10 is analyzed by using a particle size distribution measuring method such as laser diffraction or dynamic light scattering.

The metal-air flow battery cell 100 according to the present disclosure may be a power-generating cell. During power generation, an oxidation reaction (Formula (1) below) of a solid active material takes place at the negative electrode 22, and a reduction reaction (Formula (2) below) of oxygen takes place at the positive electrode 32.

Zn+4OH→Zn(OH)₄²⁻+2e⁻→ZnO+H₂O+2OH⁻ (1)

1/2O₂+H₂O+2e⁻→2OH⁻ (2)

In a case where the metallic species is zinc, in Formula (1), metallic zinc serving as the solid active material turns into zincate ions through the oxidation reaction and further turns into zinc oxide. In Formula (2), hydroxide ions are produced by the reduction reaction of the oxygen.

The slurry 10 may also contain a thickener. Since there is a very great difference in specific gravity between the electrolytic solution 12 and the solid active material 11, the electrolytic solution 12 and the solid active material 11 separate from each other in a remarkably short length of time. Adding the thickener leads to a rise in solution viscosity. That is, containing the thickener causes a decrease in sedimentation velocity of the solid active material 11, making it possible to scatter the solid active material 11 homogenously in the slurry 10 even with passage of time. Further, the slurry 10 may also contain a gelling agent. The rise in the viscosity of the slurry 10 by the thickener leads to an increase in viscosity difference between the positive electrode and the negative electrode, leading also to a pressure difference entailed by the flow of the slurry 10. Accordingly, the object of the present disclosure becomes more prominent to bring about a greater effect.

The concentration of the thickener may be higher than or equal to 0.75 wt % and lower than 3 wt % in the slurry 10.

Although the average particle diameter of the metallic species has been mentioned above, the average particle diameter of the solid active material 11 in a state of reduction in which it is not an oxide may range from 30 μm to 300 μm.

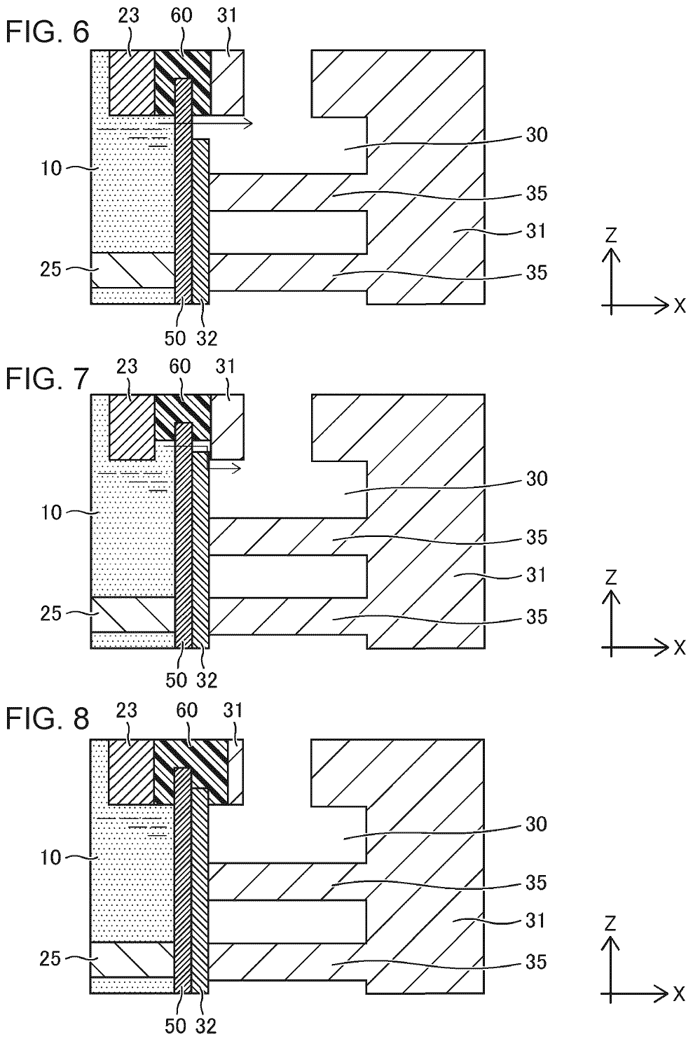

FIG. 6 is an enlarged view of portion VI of FIG. 5. As shown in FIG. 6, the metal-air flow battery cell 100 according to the present disclosure includes a porous positive electrode 32, provided beside the positive-electrode energization plate 31, that covers at least part of the separator 50, contains water-repellent resin, and includes fine pores. Placing the positive electrode 32 so that the positive electrode 32 covers at least part of the separator 50 reduces exposure to the positive electrode chamber 30 of a surface of the separator 50 that faces the positive electrode 32, thus making it possible to further inhibit the electrolytic solution 12 from penetrating from the negative electrode chamber 20 into the positive electrode chamber 30. Further, it is more difficult for the electrolytic solution 12 to penetrate into the positive electrode 32, which contains water-repellent resin and has porosity as mentioned earlier, than into the separator 50, and even in a case where the electrolytic solution 12 excessively penetrates through the separator 50 in a direction from the negative electrode chamber 20 to the positive electrode chamber 30 as shown in FIG. 6, the electrolytic solution 12 is further inhibited from penetrating into the positive electrode chamber 30 through a portion of the separator 50 covered with the positive electrode 32.

FIG. 7 is a modification of FIG. 6. The metal-air flow battery cell 100 according to the present disclosure may be configured such that the separator 50 is not exposed to the positive electrode chamber 30. As shown in FIG. 7, by covering the surface of the separator 50 that faces the positive electrode 32 with the positive electrode 32 so that the surface of the separator 50 that faces the positive electrode 32 is not exposed to the positive electrode chamber 30 and thereby removing exposure of the surface of the separator 50 that faces the positive electrode 32, the electrolytic solution 12 can be further inhibited from penetrating from the negative electrode chamber 20 into the positive electrode chamber 30.

FIG. 8 is a modification of FIG. 7. As shown in FIG. 8, the metal-air flow battery cell 100 according to the present disclosure includes a sealing portion 60, provided between a negative electrode flow path layer 23 provided in an end portion of the negative-electrode energization plate 21 and the positive-electrode energization plate 31, that supports the separator 50. The sealing portion 60 supports and covers at least an end portion of the positive electrode 32. That is, as shown in FIG. 8, a surface of an end portion of the separator 50 that faces the positive electrode 32 is covered with the sealing portion 60 and the positive electrode 32 and is not exposed to the positive electrode chamber 30. This causes the sealing portion 60 to exist at the interface between the end portion of the positive electrode 32 and the positive-electrode energization plate 31 so that there is no gap between the negative electrode chamber 20 and the positive electrode chamber 30, thus making it possible to further inhibit the electrolytic solution 12 from penetrating from the negative electrode chamber 20 into the positive electrode chamber 30.

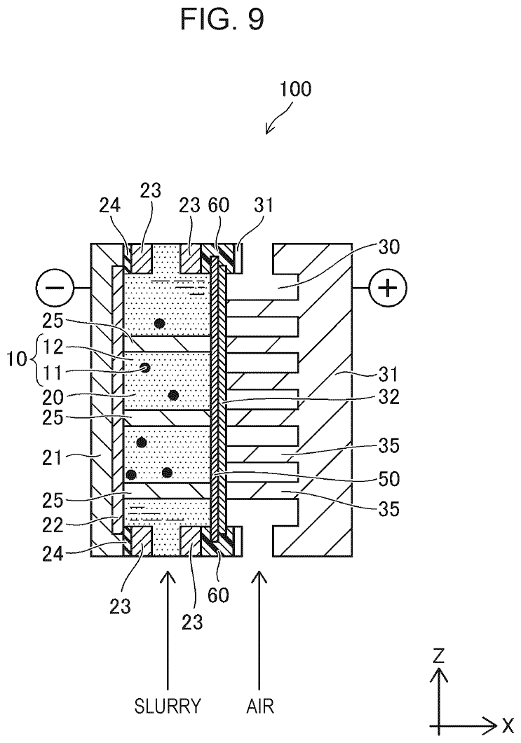

FIG. 9 is a schematic cross-sectional view of a metal-air flow battery cell according to the present disclosure. As shown in FIG. 9, the metal-air flow battery cell according to the present disclosure includes negative electrode chamber rib portions 25 forming the negative electrode chamber 20 and positive electrode chamber rib portions 35 forming the positive electrode chamber 30.

Moreover, as shown in FIG. 9, the negative electrode chamber rib portions 25 may be disposed to overlap at least some of the positive electrode chamber rib portions 35. That is, there are parts where the negative electrode chamber rib portions 25 and the positive electrode chamber rib portions 35 overlap each other in the X-axis direction. This forms parts of the separator 50 and the positive electrode 32 that are fixedly sandwiched between the negative electrode chamber rib portions 25 and the positive electrode chamber rib portions 35 (i.e. the parts where the negative electrode chamber rib portions 25 and the positive electrode chamber rib portions 35 overlap each other in the X-axis direction), thus making it possible to inhibit deformation of the separator 50 and the positive electrode 32 even if there is a pressure difference between the negative electrode chamber 20 and the positive electrode chamber 30 and making it possible to, by inhibiting deformation of the separator 50 and the positive electrode 32, inhibit breakage and perforation of the separator 50 and the positive electrode 32. This makes it possible to further inhibit the electrolytic solution 12 from penetrating from the negative electrode chamber 20 into the positive electrode chamber 30.

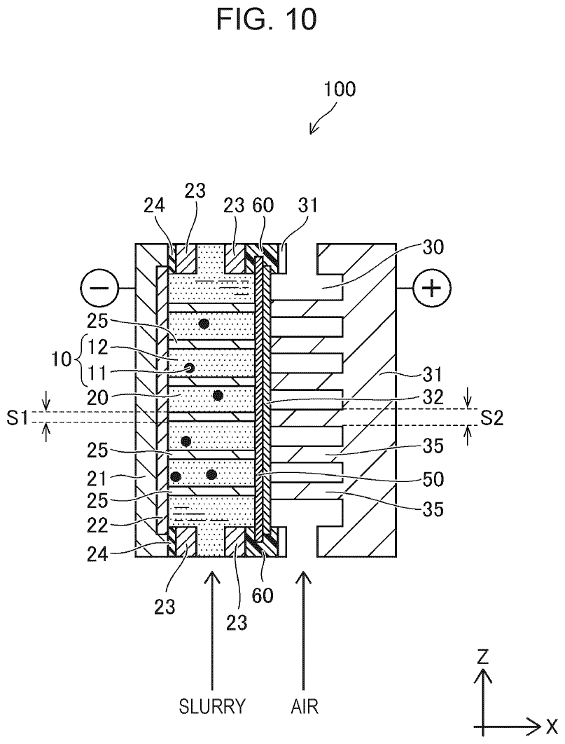

As shown in FIG. 10, the negative electrode chamber rib portions 25 may be disposed to overlap all of the positive electrode chamber rib portions 35. That is, the negative electrode chamber rib portions 25 and the positive electrode chamber rib portions 35 are placed parallel to each other, and all of the negative electrode chamber rib portions 25 and the positive electrode chamber rib portions 35 are linearly placed on the X axis. This causes the separator 50 and the positive electrode 32 to be sandwiched between the negative electrode chamber rib portions 25 and the positive electrode chamber rib portions 35, thus making it possible to further inhibit deformation of the separator 50 even if there is a pressure difference between the negative electrode chamber 20 and the positive electrode chamber 30 and making possible to further inhibit the electrolytic solution 12 from penetrating from the negative electrode chamber 20 into the positive electrode chamber 30.

Further, a pitch T1 between the negative electrode chamber rib portions 25 may be n times greater than a pitch T2 between the positive electrode chamber rib portions 35, and n may be greater than or equal to 1.

n may be an integer, and more preferably, n may be 1. That is, the pitch T1 between the negative electrode chamber rib portions 25 and the pitch T2 between the positive electrode chamber rib portions 35 become equal to each other, and a width S1 of each of the negative electrode chamber rib portions 25 becomes smaller than a width S2 of each of the positive electrode chamber rib portions 35.

Meanwhile, the aforementioned n may be greater than or equal to 2. In that case, there is no restrictions on the width S1 of each of the negative electrode chamber rib portions 25 and the width S2 of each of the positive electrode chamber rib portions 35.

The positive electrode chamber rib portions 35 may be placed parallel to the negative electrode chamber rib portions 25. This leads to an increase in reactive area of an electrode in view of a projected area.

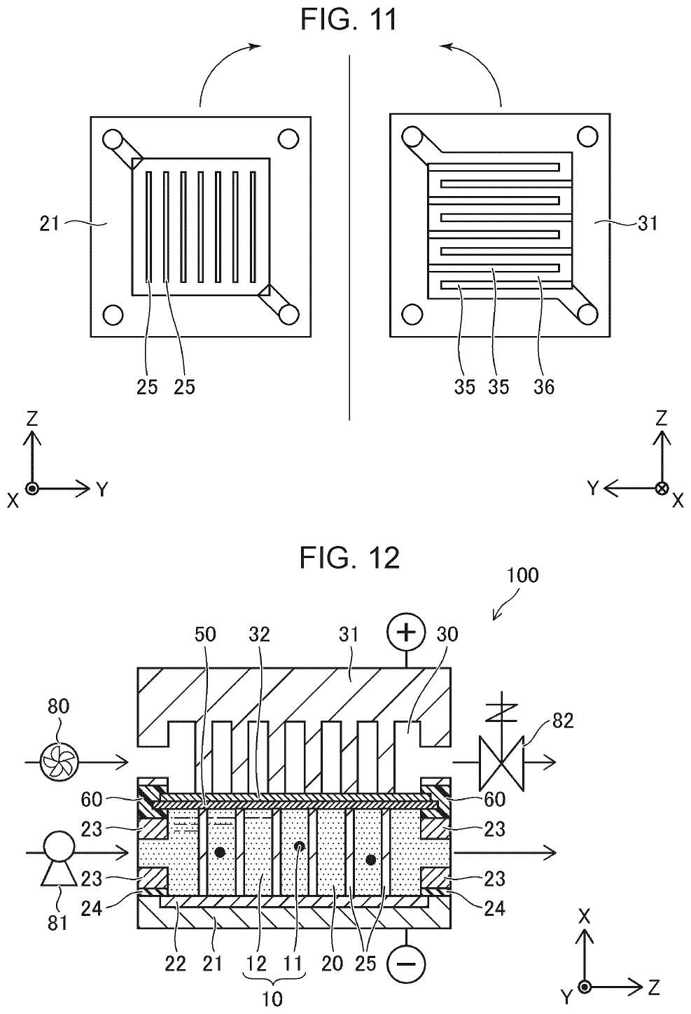

FIG. 11 is an assembly diagram of the negative-electrode energization plate 21 and the positive-electrode energization plate 31. As shown in FIG. 11, the metal-air flow battery cell 100 according to the present disclosure is assembled by folding the negative-electrode energization plate 21 and the positive-electrode energization plate 31 in the directions of arrows symmetrically with respect to a line in the drawing. At this point in time, the negative electrode chamber rib portions 25 may be placed orthogonal to the positive electrode chamber rib portions 35.

This forms a lattice configuration of points at which the negative electrode chamber rib portions 25 and the positive electrode chamber rib portions 35 overlap each other, thus making it possible to effectively inhibit deformation of the separator 50 and the positive electrode 32 and making it possible to, by inhibiting deformation of the separator 50 and the positive electrode 32, reduce breakage and perforation of the separator 50 and the positive electrode 32. This makes it possible to further inhibit the electrolytic solution 12 from penetrating from the negative electrode chamber 20 into the positive electrode chamber 30.

Further, as shown in FIGS. 4 and 11, the positive electrode chamber 30 may include a serpentine flow path portion 36. The serpentine flow path portion 36 is a serpentine continuous flow path. Since making a flow path a serpentine flow path results in a longer flow path length, this makes it possible to increase pressure in the positive electrode chamber 30, thus making it possible to reduce a pressure difference between the negative electrode chamber 20 and in the positive electrode chamber 30 and making it possible to further inhibit the electrolytic solution 12 from penetrating from the negative electrode chamber 20 into the positive electrode chamber 30. The serpentine flow path portion 36 may be provided in the negative electrode chamber 20 and is not confined to the positive electrode chamber 30.

FIG. 12 is a diagram explaining that a back pressure valve 82 or other devices are provided at an outlet and an inlet of a metal-air flow battery cell 100 according to the present disclosure. As shown in FIG. 12, the metal-air flow battery cell 100 according to the present disclosure includes a blower 80, a pump 81, and a back pressure valve 82 at a flow path outlet and a flow path inlet of the negative electrode chamber 20 and/or the positive electrode chamber 30.

The blower 80 is provided at the inlet of the positive electrode chamber 30 and sends, for example, air to the positive electrode chamber 30.

The back pressure valve 82 is provided at the outlet of the positive electrode chamber 30 and controls emission of the air sent from the blower 80. Thus, reducing emission of air by providing the back pressure value 82 in a path of emission of air makes it possible to reduce a pressure difference between the negative electrode chamber 20 by increasing pressure in the positive electrode chamber 30 and makes it possible to further inhibit the electrolytic solution 12 from penetrating from the negative electrode chamber 20 into the positive electrode chamber 30.

The pump 81 is provided at the inlet of the negative electrode chamber 20 and sends the slurry 10 to the negative electrode chamber 20. Further, the slurry 10 may be caused by the pump 81 to intermittently flow through the negative electrode chamber 20. The intermittent flow of the slurry 10 means that the slurry 10 flows not continuously but on and off. This reduces a pressure difference between the negative electrode chamber 20 and the positive electrode chamber 30 at all times by allowing time for pressure relaxation without an increase in pressure in the negative electrode chamber 20. Further, during stoppage of the flow of the slurry 10 through a negative electrode flow path, a pressure difference between the negative electrode chamber 20 and the positive electrode chamber 30 is reversed by continuing to cause air to flow through the positive electrode chamber 30. This makes it possible to, in the event of excessive penetration of the electrolytic solution 12 from the negative electrode chamber 20 into the positive electrode chamber 30, push back the penetration in an opposite way.

Thus, the metal-air flow battery cell 100 according to the present disclosure makes it possible to reduce a pressure difference between the negative electrode chamber 20 and the positive electrode chamber 30 by increasing pressure on the side of the positive electrode 32.

Although, in the foregoing embodiment, the metal-air flow battery cell 100 has been described, for example, as a cell that constitutes the power-generating unit 2, the metal-air flow battery cell 100 may be used as a cell that constitutes the charging unit 3.

Although the foregoing embodiment has been described by taking the metal-air flow battery cell 100 as an example, the metal-air flow battery cell 100 needs only be a flow battery cell and is not limited to a metal-air battery. In the case of a flow battery cell, it does not necessarily need to contain the slurry 10 during shipment.

While embodiments and examples of the present disclosure have been described in detail above, it will easily understand by those skilled in the art that a large number of modifications can be made without substantially departing from new matters or effects of the present disclosure. Accordingly, such modifications shall all be encompassed in the scope of the present disclosure.

For example, in the description or the drawings, a term used at least once together with a different term that is broader or synonymous can be substituted by the different term in any part of the description or the drawings. Further, the configuration and operation of a metal-air flow battery can be variously modified without being limited to those described in embodiments and examples of the present disclosure.

While there have been described what are at present considered to be certain embodiments of the invention, it will be understood that various modifications may be made thereto, and it is intended that the appended claims cover all such modifications as fall within the true spirit and scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A flow battery cell comprising:
a separator;
a negative electrode chamber; and
a positive electrode chamber placed opposite the negative electrode chamber across the separator,
wherein a flow path width of the positive electrode chamber is smaller than a flow path width of the negative electrode chamber.

2. The flow battery cell according to claim 1, wherein air flows through the positive electrode chamber.

3. The flow battery cell according to claim 1, comprising slurry in the negative electrode chamber.

4. A metal-air flow battery cell comprising:

1. w battery cell according to claim 1; and
slurry that flows through the negative electrode chamber,
wherein air flows through the positive electrode chamber.

5. The metal-air flow battery cell according to claim 4, wherein the separator is a hydrogel membrane.

6. The metal-air flow battery cell according to claim 4, wherein
a positive-electrode energization plate is formed so as to surround the positive electrode chamber, and
the positive-electrode energization plate is formed so as to overlap the separator,
the metal-air flow battery cell comprising a porous positive electrode, provided closer to the positive-electrode energization plate than is the separator, that covers at least part of the separator and contains water-repellent resin.

7. The metal-air flow battery cell according to claim 6, wherein the separator is not exposed to the positive electrode chamber.

8. The metal-air flow battery cell according to claim 7, comprising a sealing portion, provided between a negative electrode flow path layer provided in an end portion of the negative-electrode energization plate and the positive-electrode energization plate, that supports the separator,
wherein an end portion of the positive electrode is covered with the sealing portion.

9. The metal-air flow battery cell according to claim 4, comprising:
one or more negative electrode chamber rib portions forming the negative electrode chamber; and
one or more positive electrode chamber rib portions forming the positive electrode chamber,
wherein the one or more negative electrode chamber rib portions are disposed to overlap at least some of the one or more positive electrode chamber rib portions.

10. The metal-air flow battery cell according to claim 9, wherein
a pitch between the one or more negative electrode chamber rib portions is n times greater than a pitch between the one or more positive electrode chamber rib portions, and
n is greater than or equal to 1.

11. The metal-air flow battery cell according to claim 10, wherein n is an integer greater than or equal to 2.

12. The metal-air flow battery cell according to claim 4, comprising:
one or more negative electrode chamber rib portions forming the negative electrode chamber; and
one or more positive electrode chamber rib portions forming the positive electrode chamber,
wherein
a pitch between the one or more negative electrode chamber rib portions is n times greater than a pitch between the one or more positive electrode chamber rib portions, and
n is greater than or equal to 2.

13. The metal-air flow battery cell according to claim 10, wherein n is 1.

14. The metal-air flow battery cell according to claim 13, wherein the one or more negative electrode chamber rib portions are disposed to overlap all of the one or more positive electrode chamber rib portions.

15. The metal-air flow battery cell according to claim 9, wherein the one or more negative electrode chamber rib portions are placed parallel to the one or more positive electrode chamber rib portions.

16. The metal-air flow battery cell according to claim 9, wherein the one or more negative electrode chamber rib portions are placed orthogonal to the one or more positive electrode chamber rib portions.

17. The metal-air flow battery cell according to claim 4, comprising a back pressure valve.

18. The metal-air flow battery cell according to claim 4, wherein the positive electrode chamber includes a serpentine flow path portion.

19. The metal-air flow battery cell according to claim 4, wherein the slurry intermittently flows through the negative electrode chamber.

20. The metal-air flow battery cell according to claim 4, wherein the slurry contains a solid active material.
